(19) United States
(12) Patent Application Publication
(10) Pub. No.: US 2022/0170131 A1
(43) Pub. Date: Jun. 2, 2022

(54) METHOD OF MANUFACTURING LOW IRON LOSS GRAIN ORIENTED ELECTRICAL STEEL SHEET

(71) Applicant: JFE Steel Corporation, Tokyo (JP)

(72) Inventors: Ryuichi Suehiro, Tokyo (JP); Takashi Terashima, Tokyo (JP); Toshito Takamiya, Tokyo (JP); Makoto Watanabe, Tokyo (JP); Masanori Uesaka, Tokyo (JP)

(21) Appl. No.: 17/674,264

(22) Filed: Feb. 17, 2022

Related U.S. Application Data
(62) Division of application No. 15/516,935, filed on Apr. 5, 2017.

(30) Foreign Application Priority Data
Oct. 6, 2014 (JP) 2014-205426

(51) Int. Cl. C21D 9/46; C21D 8/12; C22C 38/02; C22C 38/04; C22C 38/60; C22C 38/00; H01F 1/147; C21D 8/00; C22C 38/06; C22C 38/12; C22C 38/16; C22C 38/54

(52) U.S. Cl. CPC C21D 9/46; C21D 2201/05; C22C 38/02; C22C 38/04; C22C 38/60; C22C 38/00; H01F 1/14775; C21D 8/1294; C21D 8/005; C21D 8/1261; C21D 8/1288; C22C 38/001; C22C 38/002; C22C 38/008; C22C 38/06; C22C 38/12; C22C 38/16; C22C 38/54; C21D 8/1272

(57) ABSTRACT

A method of manufacturing a grain oriented electrical steel sheet includes hot rolling a steel slab having a chemical composition including C: 0.002-0.10 mass %, Si: 2.5-5.0 mass %, Mn: 0.01-0.8 mass %, Al: 0.010-0.050 mass % and N: 0.003-0.020 mass % and the remainder being Fe and inevitable impurities to form a hot rolled sheet; subjecting the hot rolled sheet to one cold rolling or two or more cold rollings and interposing an intermediate annealing therebetween after hot band annealing or without hot band annealing to form a cold rolled sheet having a final thickness; subjecting the cold rolled sheet to a primary recrystallization annealing; applying an annealing separator to the surface of the steel sheet; and subjecting the sheet to a finish annealing and forming a tension coating.

### TECHNICAL FIELD

This disclosure relates to a grain oriented electrical steel sheet suitable for use as an iron core material of transformers and the like and having excellent magnetic properties, particularly an iron loss property and a method of manufacturing the same.

### BACKGROUND

Grain oriented electrical steel sheets are magnetic materials mainly used as iron core materials for transformers, power generators, rotary machines and so on and are demanded to be low in the energy loss (iron loss) generated in the inside of the iron core by excitation.

As one method of decreasing the iron loss of the grain oriented electrical steel sheet, there is a technique wherein Goss orientation of crystal grains ({110}<001>) is highly aligned in one direction toward the rolling direction of the steel sheet to realize a high permeability. That technique utilizes a phenomenon called as secondary recrystallization in which crystal grains of a specified orientation, or Goss orientation are coarsely grown while consuming crystal grains of the other orientations. By the secondary recrystallization is directed <001> orientation as an axis of easy magnetization of iron toward the rolling direction, whereby permeability in the rolling direction is significantly improved and hysteresis loss is reduced.

However, crystal grains having an orientation deviated from the ideal Goss orientation are also generated by the secondary recrystallization so that an industrially produced grain oriented steel sheet becomes a polycrystalline body having some orientation scatterings. To this end, proper control of the orientation scatterings is an important development subject in the grain oriented electrical steel sheet. For example, JP-A-2001-192785 discloses that excellent magnetic properties are obtained by sharpening an angle α deviated from {110}<001> ideal orientation around a direction perpendicular to the rolling face (ND, thickness direction) in the whole of secondary recrystallized grains to not more than an appropriate value and suppressing variation of an angle β deviated from {110}<001> around a direction perpendicular to the rolling direction (TD, widthwise direction). In that technique, however, the secondary recrystallized grains becomes enormous so that eddy current loss is not sufficiently reduced and the decrease of iron loss is critical though hysteresis loss property is excellent.

Therefore, methods of decreasing the iron loss by controlling a factor other than the orientation scatterings of the secondary recrystallized grains are examined, one of which is a technique wherein secondary recrystallized grain size is refined to make a magnetic domain width small and decrease eddy current loss. For example, Japanese Patent No. 2983128 proposes a technique wherein a grain size after the secondary recrystallization is refined by heating to a temperature of not lower than 700° C. at a heating rate of not less than 100° C./s in the heating process for decarburization annealing. Also, there is a technique wherein magnetic domains are refined to decrease the eddy current loss by intentionally forming strain regions in a direction crossing to the rolling direction of the steel sheet surface or periodically forming portions removed from the surface layer of the steel sheet (grooves) in the rolling direction. For example, Japanese Patent No. 4510757 proposes a technique of decreasing the iron loss by irradiating a laser to the surface of the grain oriented electrical steel sheet after finish annealing to refine the magnetic domains, JP-B-S62-053579 proposes a technique of decreasing the iron loss by applying a pressure to the grain oriented electrical steel sheet after finish annealing to form grooves in an iron matrix portion and refine magnetic domains and then performing strain-relief annealing, and JP-A-2013-077380 proposes a technique wherein the iron loss property is improved by subjecting to a magnetic domain refining treatment while making the secondary recrystallized grain size to not less than 10 mm and highly sharpening an average value of angle β to not more than 2°.

As mentioned above, the iron loss property of the grain oriented electrical steel sheet has been largely improved by applying the technique of forming grooves or strain regions in the surface of the steel sheet to attain magnetic domain refining. However, the margin of improvement of the iron loss property by the above techniques is not yet sufficient in view of the recent demands for improvement of the iron loss property so that further improvement is required.

It could therefore be helpful to provide a grain oriented electrical steel sheet having a better iron loss property and propose an advantageous manufacturing method thereof.

### SUMMARY

The magnetic domain refining technique of forming the groove or strain region in the surface of the steel sheet utilizes an idea that the width of the main magnetic domain is decreased to mitigate a high energy state generated in the locally introduced groove part or strain region part to thereby decrease the eddy current loss. That is, when the groove is introduced, a magnetic pole is generated in the groove part, while when strain region is introduced, a magnetic domain structure called as closure domain is generated in the strain region part, whereby the high energy state is caused so that the phenomenon of making the width of the main magnetic domain narrow is utilized for mitigating the high energy state. On the other hand, the technique of refining the secondary recrystallized grains can be considered to be refining of domains using grain boundaries as a generation site of the magnetic pole.

To this end, the effect by the magnetic domain refining treatment of forming the groove or strain region has been considered to be the same as the effect by refining the secondary recrystallized grains so that when the magnetic domain refining treatment is performed to form the grooves or strain regions in the steel sheet, the secondary recrystallized grains may be coarse and hence the refining of the secondary recrystallized grains is not performed.

We found that even when the magnetic domain refining treatment of forming the grooves or strain regions in the steel sheet surface is applied to further improve the magnetic properties of the grain oriented electrical steel sheet, it is effective to refine the secondary recrystallized grains, and particularly better magnetic properties (iron loss property) are stably obtained by controlling an average value [β] of the angle β deviated from {110}<001> ideal orientation of the secondary recrystallized grains around the widthwise direction to a proper range depending on the secondary recrystallized grain size.

We thus provide a grain oriented electrical steel sheet having a chemical composition comprising Si: 2.5-5.0 mass % and Mn: 0.01-0.8 mass % and the remainder being Fe and inevitable impurities, wherein continuous or discontinuous linear grooves or linear strain regions are formed on one surface or both surfaces of the steel sheet in a direction crossing the rolling direction at an interval d in the rolling direction of 1-10 mm and a forsterite film and a tension coating are formed on the both surfaces of the steel sheet, characterized in that an area ratio S_{α6.5} of secondary recrystallized grains occupied in the surface of the steel sheet is not less than 90% when an absolute value of an angle α deviated from {110}<001> ideal orientation around a direction perpendicular to a rolling face is less than 6.5° and an area ratio S_{β2.5} of secondary recrystallized grains occupied in the surface of the steel sheet is not less than 75% when an absolute value of an angle β deviated from {110}<001> ideal orientation around a widthwise direction is less than 2.5°, and an average length [L] (mm) of the secondary recrystallized grains in the rolling direction and an average value [β] of the angle β (°) satisfy equations (1) and (2):

15.63×[β]+[L]<44.06 (1)

[L]≤20 (2).

The grain oriented electrical steel sheet is characterized by containing one or more selected from Cr: 0.01-0.50 mass %, Cu: 0.01-0.50 mass %, P: 0.005-0.50 mass %, Ni: 0.010-1.50 mass %, Sb: 0.005-0.50 mass %, Sn: 0.005-0.50 mass %, Bi: 0.005-0.50 mass %, Mo: 0.005-0.10 mass %, B: 0.0002-0.0025 mass %, Te: 0.0005-0.010 mass %, Nb: 0.0010-0.010 mass %, V: 0.001-0.010 mass % and Ta: 0.001-0.010 mass % in addition to the above chemical composition.

Also, we provide a method of manufacturing the aforementioned grain oriented electrical steel sheet comprising a series of steps of hot rolling a steel slab having a chemical composition comprising C: 0.002-0.10 mass %, Si: 2.5-5.0 mass %, Mn: 0.01-0.8 mass %, Al: 0.010-0.050 mass % and N: 0.003-0.020 mass % and the remainder being Fe and inevitable impurities to form a hot rolled sheet, subjecting the hot rolled sheet to one cold rolling or two or more cold rollings interposing an intermediate annealing therebetween after hot band annealing or without hot band annealing to form a cold rolled sheet having a final thickness, subjecting the cold rolled sheet to a primary recrystallization annealing, applying an annealing separator to the surface of the steel sheet, subjecting the sheet to a finish annealing and forming a tension coating, characterized in that the sheet is subjected to a temperature holding treatment at any temperature T within a range of 250−600° C. for 1-10 seconds in a heating process of the primary recrystallization annealing and then heated from the temperature T to 700° C. at a heating rate of not less than 80° C./s, and a ratio (Iₘₐₓ/Iₘᵢₙ) of a maximum value Iₘₐₓ in an emission intensity profile in a depth direction of Si to a minimum value Iₘᵢₙ found in a position deeper than the maximum value Iₘₐₓ when the steel sheet surface after the primary recrystallization annealing is observed by a glow discharge optical emission spectrometry is not less than 1.5, and continuous or discontinuous linear grooves or linear strain regions are formed on one surface or both surfaces of the steel sheet in a direction crossing the rolling direction at an interval d in the rolling direction of 1-10 mm in any process after the cold rolling.

The steel slab used in the method is characterized by containing one or two selected from Se: 0.003-0.030 mass % and S: 0.002-0.030 mass % in addition to the above chemical composition.

The steel slab used in the method is characterized by containing one or more selected from Cr: 0.01-0.50 mass %, Cu: 0.01-0.50 mass %, P: 0.005-0.50 mass %, Ni: 0.010-1.50 mass %, Sb: 0.005-0.50 mass %, Sn: 0.005-0.50 mass %, Bi: 0.005-0.50 mass %, Mo: 0.005-0.10 mass %, B: 0.0002-0.0025 mass %, Te: 0.0005-0.010 mass %, Nb: 0.0010-0.010 mass %, V: 0.001-0.010 mass % and Ta: 0.001-0.010 mass % in addition to the above chemical composition.

When the magnetic domain refining treatment is performed by forming the linear grooves or strain regions on the surface of the grain oriented electrical steel sheet, the effect of improving the iron loss property by the magnetic domain refining can be developed maximally by controlling the grain size and crystal orientation of the secondary recrystallized grains to proper ranges so that it is possible to provide grain oriented electrical steel sheets having an iron loss lower than that of the conventional sheet.

We further provide a method of manufacturing a grain oriented electrical steel sheet including hot rolling a steel slab having a chemical composition including C: 0.002-0.10 mass %, Si: 2.5-5.0 mass %, Mn: 0.01-0.8 mass %, Al: 0.010-0.050 mass % and N: 0.003-0.020 mass % and the remainder being Fe and inevitable impurities to form a hot rolled sheet; subjecting the hot rolled sheet to one cold rolling or two or more cold rollings and interposing an intermediate annealing therebetween after hot band annealing or without hot band annealing to form a cold rolled sheet having a final thickness; subjecting the cold rolled sheet to a primary recrystallization annealing; applying an annealing separator to the surface of the steel sheet; and subjecting the sheet to a finish annealing and forming a tension coating, wherein the sheet is subjected to a temperature holding treatment at any temperature T of 250-600° C. for 1-10 seconds in a heating process of the primary recrystallization annealing and then heated from the temperature T to 700° C. at a heating rate of not less than 80° C./s, and a ratio (Iₘₐₓ/Iₘᵢₙ) of a maximum value Iₘₐₓ in an emission intensity profile in a depth direction of Si to a minimum value Iₘᵢₙ found in a position deeper than the maximum value Iₘₐₓ when the steel sheet surface after the primary recrystallization annealing is observed by a glow discharge optical emission spectrometry is not less than 1.5, and continuous or discontinuous linear grooves or linear strain regions are formed on one surface or both surfaces of the steel sheet in a direction crossing the rolling direction at an interval d in the rolling direction of 1-10 mm in any process after the cold rolling such that an area ratio S_{α6.5} of secondary recrystallized grains occupied in the surface of the steel sheet is not less than 90% when an absolute value of an angle α deviated from {110}<001> ideal orientation around a direction perpendicular to a rolling face is less than 6.5° and an area ratio S_{β2.5} of secondary recrystallized grains occupied in the surface of the steel sheet is not less than 75% when an absolute value of an angle β deviated from {110}<001> ideal orientation around a widthwise direction is less than 2.5°, and an average length [L] (mm) of the secondary recrystallized grains in the rolling direction and an average value [β] of the angle β (°) satisfy equations (1) and (2):

15.63×[β]+[L]<44.06 (1)

[L]≤20 (2).

### BRIEF DESCRIPTION OF THE DRAWINGS

FIG. 1 is a graph showing an influence of an average value [β] of an angle β deviated from {110}<001> ideal orientation of secondary recrystallized grains around a widthwise direction and an average length [L] of secondary recrystallized grains in a rolling direction upon an iron loss W_{17/50}.

FIG. 2 is a graph showing a relation between an area ratio S_{α6.5} of secondary recrystallized grains having a deviation angle α of less than 6.5° and an iron loss W_{17/50}.

FIG. 3 is a graph showing a relation between an area ratio S_{β2.5} of secondary recrystallized grains having a deviation angle β of less than 2.5° and an iron loss W_{17/50}.

FIG. 4 is a graph showing an influence of an area ratio S_{α6.5} of secondary recrystallized grains having a deviation angle α of less than 6.5° and an area ratio S_{β2.5} of secondary recrystallized grains having a deviation angle β of less than 2.5° upon an iron loss W_{17/50}.

FIG. 5 is an explanatory diagram of a method of determining a ratio (Iₘₐₓ/Iₘᵢₙ) of maximum value Iₘₐₓ to minimum value Iₘᵢₙ in an emission intensity profile in a depth direction of Si.

### DETAILED DESCRIPTION

It is first necessary that the magnetic domain refining treatment is performed by forming linear grooves or linear strain regions on one surface or both surfaces of the steel sheet to decrease an iron loss. The linear grooves or strain regions formed on the steel sheet surface for the magnetic domain refining are introduced in a direction intersecting at an angle near to 90° with respect to the rolling direction. As the intersecting angle becomes smaller, the effect of improving the iron loss property by the magnetic domain refining becomes smaller so that it is desirable to be a range of 90-60°. Moreover, the grooves may be formed in a continuous linear form or may be formed in a discontinuous linear form repeating a specified unit such as dashed line or dot sequence.

The interval d of the linear grooves or linear strain regions in the rolling direction of the steel sheet during the magnetic domain refining treatment is necessary to be a range of 1-10 mm. When the interval exceeds 10 mm, the effect by the magnetic domain refining is not obtained sufficiently, while when it is less than 1 mm, a ratio of groove or strain region parts occupied in the steel sheet becomes larger and hence an apparent magnetic flux density lowers and hysteresis loss increases. Preferably, it is 2-8 mm.

It is necessary that grain size and crystal orientation of secondary recrystallized grains are controlled to proper ranges described later to decrease the iron loss.

Various grain oriented electrical sheets are manufactured by forming continuous linear grooves of 80 μm width and 25 μm depth on one surface of a grain oriented electrical steel sheet containing Si of 3.4 mass % at an intersecting angle of 70° with respect to the rolling direction and at an interval d in the rolling direction of 3.5 mm and forming a forsterite film and a phosphate-based glass tension coating on both surfaces of the steel sheet, from which cut out test specimens of 100 mm width and 300 mm length in the rolling direction as a lengthwise direction. With respect to these test specimens are measured an angle α deviated from {110}<001> ideal orientation of secondary recrystallized grains around a direction perpendicular to a rolling face, an angle β deviated from {110}<001> ideal orientation of secondary recrystallized grains around a widthwise direction, an average length [L] of secondary recrystallization in the rolling direction and an iron loss W_{17/50}.

The iron loss W_{17/50} is an iron loss value of the each test specimen measured by a method described in JIS C2556.

Each of the deviation angle α and deviation angle β is an average value of each of an angle α deviated from {110}<001> ideal orientation of secondary recrystallized grains around a direction perpendicular to a rolling face, an angle β deviated from {110}<001> ideal orientation of secondary recrystallized grains around a widthwise direction measured over the whole of the test specimen at a pitch of 2 mm in widthwise direction and lengthwise direction with a general-purpose X-ray diffraction apparatus.

The average length [L] of secondary recrystallized grains in the rolling direction is an average grain size determined by removing the films from the surface of the test specimen after the measurement of the iron loss, drawing straight lines extending in the rolling direction at a pitch of 5 mm in widthwise direction and dividing a length of the straight line by the number of grain boundaries crossing the straight line.

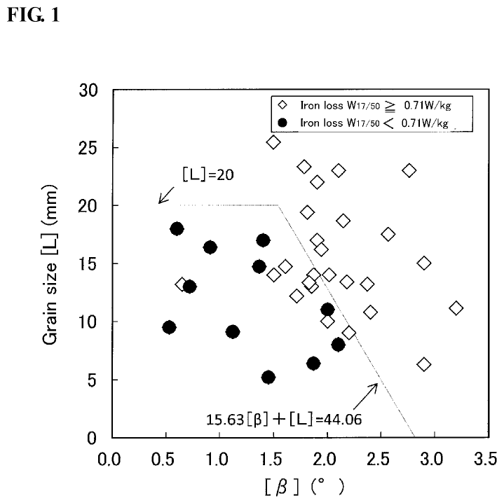

FIG. 1 shows an influence of an average value [β] of the deviation angle β and an average length [L] in the rolling direction of the secondary recrystallized grains upon an iron loss W_{17/50}. As seen from this figure, in the test specimen showing such a good property that the iron loss W_{17/50} is less than 0.71 W/kg, the average length [L] (mm) of the secondary recrystallized grains in the rolling direction and the average value [β]) (° of the angle β are in ranges satisfying equations (1) and (2):

15.63×[β]+[L]<44.06 (1)

[L]≤20 (2).

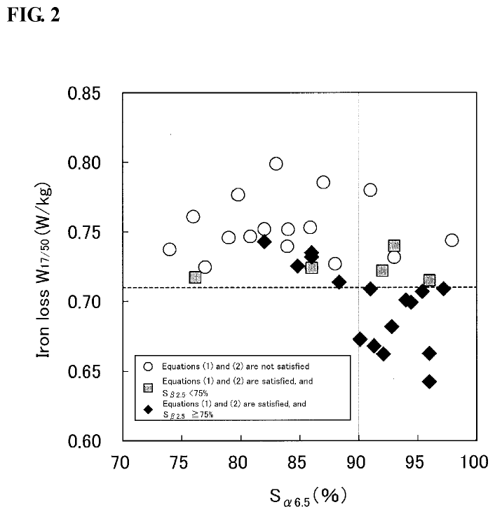

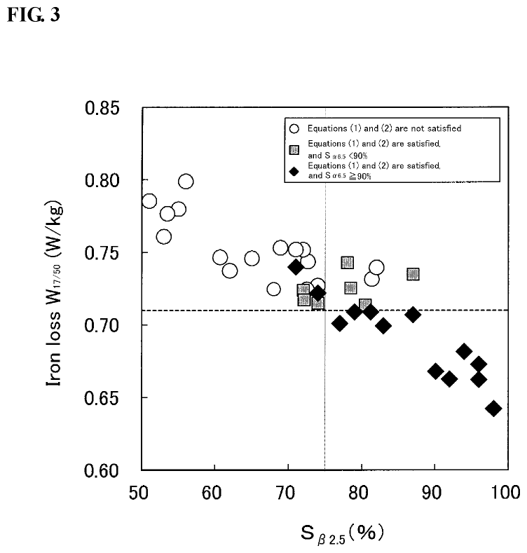

However, the test specimens having an iron loss W_{17/50} of not less than 0.71 W/kg also exist within the above ranges. Therefore, a relation between an area ratio S_{α6.5} of crystal grains at a deviation angle α of not more than 6.5° and an iron loss W_{17/50} and a relation between an area ratio S_{β2.5} of crystal grains at a deviation angle β of not more than 2.5° and an iron loss W_{17/50} are investigated, and the results thereof are shown in FIGS. 2 and 3.

The area ratio S_{α6.5} and the area ratio S_{β2.5} are a ratio (%) of measuring points at a deviation angle α of not more than 6.5° and a ratio (%) of measuring points at a deviation angle β of not more than 2.5°, respectively, when each point measured at a pitch of 2 mm over the full face of the test specimen is assumed as a measuring point of one crystal grain.

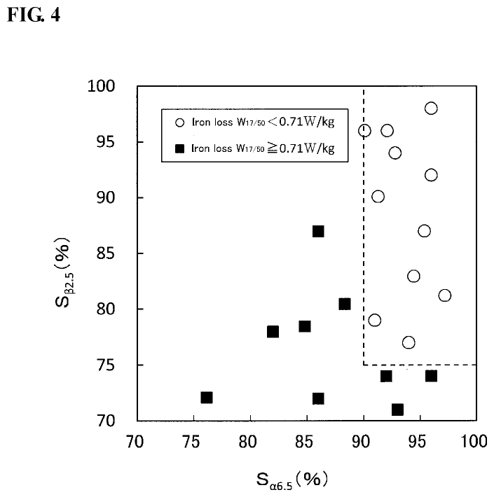

As seen from these figures, the iron loss W_{17/50} is correlated with the area ratio S_{α6.5} and the area ratio S_{β2.5}, and as the area ratios become high, the iron loss is decreased. Now, a relation among the iron loss W_{17/50}, area ratio S_{α6.5} and area ratio S_{β2.5} in the test specimens shown in FIG. 1 with an average length [L] of secondary recrystallized grains in the rolling direction and an average value [β] of an angle β satisfying the ranges of equations (1) and (2) is shown in FIG. 4. As seen from this figure, the test specimens showing such a good property that the iron loss W_{17/50} is less than 0.71 W/kg have an area ratio S_{α6.5} of not less than 90% and an area ratio S_{β2.5} of not less than 75%.

As seen from the above results so that the grain oriented electrical steel sheet has a good iron loss property, it is necessary that the average length [L] of the secondary recrystallized grains in the rolling direction and the average value [β] of the angle β have ranges satisfying equations (1) and (2) and further the area ratio S_{α6.5} is not less than 90% and the area ratio S_{β2.5} is not less than 75%. Preferably, the value in right-hand side of equation (1) is not more than 40, and the value in right-hand side of equation (2) is not more than 18, and the area ratio S_{α6.5} is not less than 93%, and the area ratio S_{β2.5} is not less than 80%.

The reason why the good iron loss property is obtained by controlling the grain size and crystal orientation of the secondary recrystallization to the above ranges is not clear sufficiently, but is considered as follows.

In the grain oriented electrical steel sheet subjected to the magnetic domain refining treatment, when the secondary recrystallization is sufficiently large as compared to the repeated interval d of the formed linear grooves or strain regions in the rolling direction, the magnetic domain refining effect by the grain boundary hardly appears. However, as the size of the secondary recrystallization comes close to the interval d to some extent, the grain boundary intersecting with the rolling direction is started to indicate an effect similar to performing additional magnetic domain refining treatment, whereby the eddy current loss is further decreased to decrease the iron loss. We believe that the above effect is developed in the magnetic domain refining treatment rendering the interval d in the rolling direction into a range of 1-10 mm when the average length [L] of the secondary recrystallized grains in the rolling direction is not more than 20 mm or satisfies equation (2).

Moreover, the above effect is not obtained simply by narrowing the interval d of the magnetic domain refining treatment in the rolling direction. This is considered due to the fact that regions subjected to the magnetic domain refining treatment (groove, strain region) are large in the total volume as compared to the grain boundaries and the iron matrix is not existent in the grooves and the magnetic permeability in the rolling direction is decreased by strain in the strain region and hence the apparent magnetic flux density lowers and the hysteresis loss increases.

As the average length [L] of the secondary recrystallized grains in the rolling direction becomes longer, the magnetic domain refining effect obtained by grain boundaries crossing to the rolling direction becomes weak so that it is necessary to supplement a deteriorated amount of the iron loss associated therewith by sharpening the crystal orientation. That is, hysteresis loss is decreased by reducing the angle β deviated from {110}<001> ideal orientation of secondary recrystallized grains around a widthwise direction, and further lancet domains (region having a magnetic moment in the widthwise direction for decreasing magnetostatic energy generated when the angle β is deviated at some degrees) are decreased to suppress the increase of the magnetic domain width, whereby eddy current loss can be decreased. Therefore, it is necessary to make the average value [β] of the deviation angle β small according to equation (1) as the average length [L] of the secondary recrystallized grains in the rolling direction becomes longer.

The reason why there is a lower limit in each of the area ratio S_{α6.5} of secondary recrystallized grains at the deviation angle α of not more than 6.5° and the area ratio S_{β2.5} of secondary recrystallized grains at the deviation angle β of not more than 2.5° is considered as follows.

Even if the average value [α] of the angle α and the average value [β] of the angle β are small, when crystal grains having an orientation largely deviated from Goss orientation are contained in the secondary recrystallized grains at an amount larger than a constant value, the magnetic properties are deteriorated and the iron loss in the whole of the steel sheet is increased. To this end, even when the average length in the rolling direction [L] and average value [β] of the deviation angle β in the secondary recrystallized grains satisfy equations (1) and (2), if the area ratio S_{α6.5} or S_{β2.5} is low, good magnetic properties cannot be obtained as shown in FIGS. 2-4.

Therefore, the deviation angle α and deviation angle β of the secondary recrystallized grains are necessary to be sharpened to a certain extent or more in the rolling direction, and critical points thereof are to be 90% in S_{α6.5} and 75% in S_{β2.5}.

In the actual manufacture of the grain-oriented electrical steel sheets, it is effective to increase the heating rate of the primary recrystallization annealing or the primary recrystallization annealing combined with decarburization annealing for reducing the average length [L] of the secondary recrystallized grains in the rolling direction. When rapid heating is performed in the heating process for the primary recrystallization annealing, the number of primary recrystallized grains having Goss orientation is increased in the structure of the steel sheet after the primary recrystallization annealing and, hence, the grain size of the secondary recrystallized grains after subsequent finish annealing can be refined.

Concretely, the rapid heating treatment has an effect of suppressing the development of <111>//ND orientation in the recrystallization texture to promote generation of Goss oriented grains ({110}<001>) as a nucleus for secondary recrystallization. In general, <111>//ND orientation is at a state that strain energy stored is high because much strain is introduced in the cold rolling as compared to the other orientations. To this end, recrystallization is preferentially caused from the rolled texture of <111>//ND orientation having a high stored strain energy in the primary recrystallization annealing of heating at a usual heating rate (about 20° C./s). In this recrystallization, <111>//ND oriented grains are usually generated from the rolled texture of <111>//ND orientation so that main orientation of the texture after the recrystallization is, <111>//ND orientation.

However, when the rapid heating is performed, the steel sheet reaches to a higher temperature in a short time so that the stored strain energy is relatively low, and recrystallization is caused from Goss orientation having a high recrystallization starting temperature as compared to <111>//ND orientation grains so that <111>//ND orientation after the recrystallization is relatively decreased and the number of Goss oriented grains ({110}<001>) increases. As the number of Goss oriented grains becomes high, many Goss oriented grains are generated even in the secondary recrystallization and the secondary recrystallized grains are refined to decrease the iron loss. It is necessary to heat a zone of 500-700° C. in the heating process at a heating rate of not less than 80° C./s to obtain such an effect. Preferably, it is not less than 120° C./s.

Also, when warm rolling is performed as the cold rolling, it is effective for refining the secondary recrystallized grains because the introduction of deformation band (shear band) into the crystal grains through the rolling is promoted and Goss orientation angle surrounded by a region having a large strain is formed in the deformation band.

Next, a technique of finely precipitating an inhibitor in steel to control the secondary recrystallization is effective to render the area ratio S_{α6.5} into not less than 90% and the area ratio S_{β2.5} into not less than 75% in addition that the above [L] and the average value [β] of the deviation angle β satisfy equations (1) and (2) through the sharpening of the crystal orientation in the secondary recrystallized grains. As the inhibitor may be used one or more selected from well-known AlN, MnS, MnSe and so on, but is not limited thereto.

Also, it is effective to increase a rolling reduction of the final cold rolling to sharpen the secondary recrystallization orientation. As the rolling reduction of the final cold rolling is increased, integration degrees of {111}<112> orientation as one of <111>//ND orientation and {12 4.1}<148> orientation are increased in the texture after the primary recrystallization. Since a crystal grain boundary among crystal grains having the two orientations and Goss oriented grains is large in the mobility as compared to the other crystal grain boundaries, preferential growth of Goss oriented grains is promoted in the finish annealing. As a result, the sharpness of the secondary recrystallization orientation into Goss orientation is improved. However, when the rolling reduction is too increased, the secondary recrystallization of Goss orientation becomes unstable. Therefore, a rolling reduction in the final cold rolling is 85-94%. Preferably, it is 87-92%.

As the rolling reduction of the final cold rolling is increased, the integration degrees to {111}<112> orientation and {12 4.1}<148> orientation are increased in the primary recrystallization texture, while Goss orientation is decreased so that the secondary recrystallized grains are coarsened. However, it is necessary to hold the grain size and crystal orientation of the secondary recrystallized grains at a proper balancing state so that the coarsening is not favorable. To refine the secondary recrystallized grains, the aforementioned rapid heating in the primary recrystallization annealing is effective, but when the rolling reduction in the final cold rolling exceeds 85%, it is difficult to ensure sufficient number of Goss oriented grains only by controlling the heating rate in the temperature zone of 500-700° C.

In addition to the aforementioned rapid heating in the heating process of the primary recrystallization annealing, therefore, it is necessary that a temperature holding treatment is performed at any temperature T of 250-600° C. in the heating process for 1-10 seconds, while a zone from the holding temperature T to 700° C. is heated at a heating rate of not less than 80° C./s.

The reason is as follows.

When the temperature holding treatment is performed by holding a temperature zone causing the recovery on the way of the rapid heating (250-600° C.) for a given time, <111>//ND orientation having a high strain energy preferentially causes the recovery. To this end, a driving force of causing recrystallization by <111>//ND orientation produced from the rolled texture of <111>//ND orientation is lowered selectively, and hence recrystallization is caused by the other orientations. As a result, the number of Goss oriented grains is relatively increased after primary recrystallization. When the holding temperature is lower than 250° C. or the holding time is less than 1 second, the recovery amount is lacking and the above effect is not obtained. On the other hand, when the holding temperature exceeds 600° C. or the holding time exceeds 10 seconds, the recovery is caused in a wider range and the recrystallization is not caused, and the recovered texture retains as it is. As a result, a texture different from the above primary recrystallization texture is formed, which badly affects the secondary recrystallization and decreases the iron loss property. Therefore, it is necessary to perform the temperature holding treatment at any temperature of 250-600° C. in the heating process of the primary recrystallization annealing for a time of 1-10 seconds.

It is necessary to heat the zone of 500-700° C. in the heating process at a heating rate of not less than 80° C./s for increasing the number of Goss oriented grains as previously mentioned. However, the holding temperature T (any temperature of 250-600° C.) is lower than 700° C. Therefore, the heating rate is necessary to be 80° C./s even in a zone from the holding temperature T to 700° C. Preferably, it is not less than 120° C./s.

To obtain the grain-oriented electrical steel sheet establishing the refining of the secondary recrystallized grains and the adjustment of the deviation angles α and β, only the aforementioned method is insufficient, and further it is necessary to take means for increasing the integration degree of secondary recrystallization orientation. Concretely, it is necessary that an average heating rate from 700° C. attained in the heating process of the primary recrystallization annealing to soaking is not more than 15° C./s, and an oxygen potential P_{H2O}/P_{H2} of an atmosphere in a zone from 700° C. to soaking is 0.2-0.4, and an oxygen potential P_{H2O}/P_{H2} in a soaking zone is 0.3-0.5.

The reason is as follows.

In a higher temperature zone of the primary recrystallization annealing, particularly a temperature zone of not lower than 700° C., an internal oxide layer mainly composed of SiO₂ is usually formed on the surface layer of the steel sheet by keeping the atmosphere at an oxidizing nature. The internal oxide layer is a ground for reacting with an annealing separator mainly composed of MgO in the subsequent finish annealing to form a forsterite film, while it has an effect of preventing such a nitriding that nitrogen in the atmosphere penetrates into the steel sheet on the way of the finish annealing and suppresses decomposition of AlN as an inhibitor. When the decomposition of AlN is blocked by nitriding, the secondary recrystallization selecting only Goss orientation is blocked and, hence, grains having an orientation deviated from Goss orientation are subjected to secondary recrystallization.

The effect of suppressing the nitriding is largely affected by the structure of the internal oxide layer. That is, the structure of the internal oxide layer effective to suppress penetration of nitrogen is such a structure that SiO₂ is laminar or finely spherical and is concentrated in a position of a specified depth of the internal oxide layer (Si enriched). When the internal oxide layer has such a structure, it effectively blocks the diffusion of nitrogen penetrated from the surface layer of the steel sheet during the finish annealing into the inside of the steel sheet and suppresses the nitriding.

The internal oxide layer having the above structure can be judged from an enriching level of Si in the oxide layer. Concretely, it is considered that the surface of the steel sheet after the primary recrystallization annealing is analyzed by a glow-discharge optical emission spectrometry device GDS to obtain a concentration distribution of Si in the depth direction (emission intensity profile), and as a value of an intensity ratio (Iₘₐₓ/Iₘᵢₙ) of a maximum emission intensity Iₘₐₓ of Si in the above emission intensity profile of Si to a minimum emission intensity Iₘᵢₙ of Si presented in a position deeper than the maximum intensity Iₘₐₓ becomes larger, enrichment of Si in the oxide layer is promoted to provide a structure suitable for suppressing the penetration of nitrogen. The value (Iₘₐₓ/Iₘᵢₙ) of the internal oxide layer effective to suppress nitriding is not less than 1.5. Moreover, the preferable value (Iₘₐₓ/Iₘᵢₙ) is not less than 1.55.

The measure of Iₘₐₓ/Iₘᵢₙ is described below.

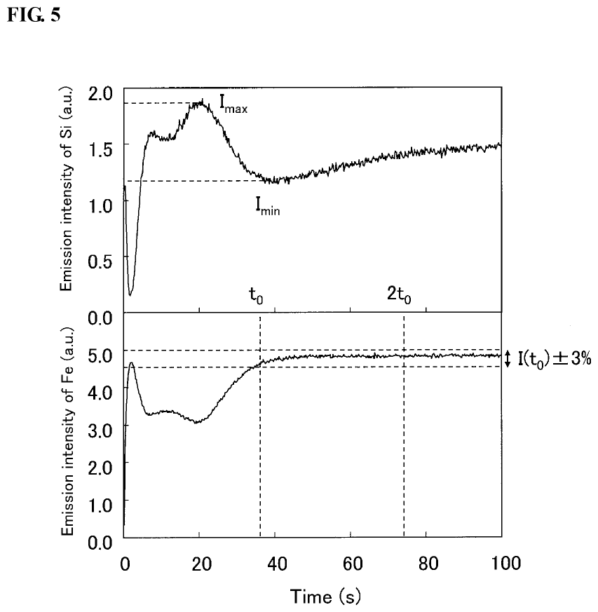

The surface of the steel sheet sample after primary recrystallization annealing is analyzed with the high-frequency glow-discharge optical emission spectrometry device to measure emission intensities of Si from outermost surface at one-side of the sample to a sufficiently deep region in a direction toward a center of the sheet thickness, and the maximum emission intensity Iₘₐₓ of Si and minimum emission intensity Iₘᵢₙ of Si presented in a position deeper than the maximum emission intensity Iₘₐₓ are determined from the thus obtained Si profile to calculate Iₘₐₓ/Iₘᵢₙ. The measurement up to the sufficiently deeper position means that as shown in FIG. 5, when an emission intensity distribution of Fe in a depth direction from the surface of the steel sheet is measured together with Si and an emission intensity of Fe at a measuring time t in a region deeper than Fe absent layer existing in the surface layer portion in which the emission intensity of Fe is increased and converged to a certain value is I_{Fe} (t) and a minimum time of an emission intensity I_{Fe} (2t) of Fe at a measuring time 2t within a range of ±3% to the above emission intensity I_{Fe} (t) is t₀, the measurement is continued at a time of 2 times or more of t₀.

To form the internal oxide layer having an enriched Si, an atmosphere at a temperature zone of not lower than 700° C. starting formation of the internal oxide layer is made to a relatively low oxidizing nature and slow heating is performed. Concretely, it is desirable that an oxygen potential P_{H2O}/P_{H2} of the atmosphere from 700° C. to the soaking temperature is within a range of 0.2-0.4 and a heating rate in the above temperature range is not more than 15° C./s. When the oxygen potential P_{H2O}/P_{H2} of the atmosphere is too high exceeding 0.4 or when the heating rate exceeds 15° C./s and the higher temperature is attained in a short time, formation of the internal oxide layer is rapidly promoted and, hence, the structure of SiO₂ is changed from the laminar or finely spherical form to a coarse spherical or dendrite form to decrease the enrichment of Si. In contrast, when the oxygen potential P_{H2O}/P_{H2} of the atmosphere is less than 0.2, the internal oxide layer is not formed sufficiently up to the arrival in the soaking, and the formation of the internal oxide layer is rapidly promoted during the soaking so that the structure becomes still coarse spherical or dendrite. Preferably, the oxygen potential P_{H2O}/P_{H2} of the atmosphere in the above temperature zone is a range of 0.25-0.35, and the heating rate of the zone is not more than 10° C./s.

Further, the oxidizing nature of the atmosphere during the soaking is important and, hence, the oxygen potential P_{H2O}/P_{H2} of the atmosphere during the soaking is necessary to be 0.3-0.5. When the oxygen potential P_{H2O}/P_{H2} is less than 0.3, the formation of the internal oxide layer is not promoted and the enrichment of Si is not caused. On the other hand, when it exceeds 0.5, the formation of the internal oxide layer is rapidly promoted. Formation of the internal oxide layer associated with the proper enrichment of Si cannot be performed. The preferable oxygen potential P_{H2O}/P_{H2} during the soaking is 0.35-0.45.

Next, the grain-oriented electrical steel sheet is necessary to be provided on the surface of the steel sheet with a forsterite film and a tension coating (insulation coating) for decreasing the iron loss.

The forsterite film can be formed by applying an annealing separator composed mainly of MgO to the surface of the steel sheet after decarburization annealing and drying it and then subjecting to a finish annealing. The forsterite film has an insulating property and an action of applying tensile stress to the surface of the steel sheet in the rolling direction to narrow the magnetic domain width and decrease the eddy current loss.

Also, the tension coating (insulation coating) can be obtained by applying a coating solution containing, for example, phosphate-chromate-colloidal silica to the surface of the steel sheet after the finish annealing and baking at a temperature of about 800° C., which has an action of increasing the insulating property of the steel sheet surface and applying tensile stress to the steel sheet surface in the rolling direction to narrow the magnetic domain width and decrease the eddy current loss like the forsterite film.

The tension applied to the steel sheet surface by these coatings is preferable to be 4.8-36 MPa per one side surface of the steel sheet from a viewpoint of effectively decreasing the eddy current loss. The magnification of the tension applied can be measured from a warping amount of the steel sheet when the coating on the one side surface of the steel sheet is removed by pickling or the like after the formation of the tension coating.

Moreover, the forsterite film is formed from a subscale formed on the steel sheet surface during decarburization annealing and composed mainly of silica as a raw material in the finish annealing so that it is necessary to form a proper amount of the subscale to ensure the insulating property and the adhesiveness of the forsterite film to the steel sheet. When a coating weight converted to oxygen is 0.30 g/m², the subscale is too small and the amount of the forsterite formed is insufficient and the insulating property and adhesiveness of the coating are lowered. On the other hand, when it exceeds 0.75 g/m², the amount of forsterite formed becomes too large to bring about the decrease of a space factor in the lamination of steel sheets. Therefore, it is preferable to restrict the coating weight converted to oxygen after the decarburization annealing to a 0.30-0.75 g/m². More preferably, it is 0.40-0.60 g/m².

There will be described the method of manufacturing the grain-oriented electrical steel sheet below.

The grain-oriented electrical steel sheet is manufactured by hot rolling a raw steel material (slab) adjusted to a predetermined chemical composition described below to form a hot rolled sheet, subjecting to one cold rolling or two or more cold rollings interposing an intermediate annealing therebetween after a hot band annealing or without hot band annealing to form a cold rolled sheet with a final thickness, subjecting to a primary recrystallization annealing or to a primary recrystallization annealing combined with decarburization annealing, applying an annealing separator to the steel sheet surface, subjecting to a finish annealing and forming an insulation coating, while performing a magnetic domain refining treatment at any step after the cold rolling.

The raw steel material (slab) used in the manufacture of the grain-oriented electrical steel sheet is necessary to contain Si of not less than 2.5 mass % for increasing a specific resistance of a product sheet (steel sheet after the finish annealing) to decrease the eddy current loss. When it is less than 2.5 mass %, the eddy current loss cannot be decreased and good iron loss property is not obtained. On the other hand, when it is contained exceeding 5 mass %, it is difficult to perform cold rolling and a risk such as sheet fracture or the like increases. Therefore, Si content is 2.5-5 mass %. Preferably, it is 2.8-4.3 mass %.

Also, the slab is necessary to contain C and Mn within ranges of C: 0.002-0.10 mass % and Mn: 0.01-0.8 mass %, respectively, in addition to Si.

C has an effect of strengthening grain boundaries to suppress slab breakage and is necessary to be contained in an amount of not less than 0.002 mass %. On the other hand, C is necessary to be decreased to not more than 0.0050 mass % at a stage of a product sheet not to cause magnetic aging. If C content in the raw steel material exceeds 0.1 mass %, there is a fear that the material cannot be decarburized sufficiently even in the decarburization annealing. Preferably, the C content of the raw steel material is 0.01-0.09 mass %.

Also, Mn is necessary to be contained in an amount of not less than 0.01 mass % to prevent hot embrittlement and ensure good hot workability. However, when it exceeds 0.8 mass %, the above effect is saturated and the magnetic flux density is decreased. Preferably, Mn content is 0.02-0.5 mass %.

Further, the slab used as a raw material for the grain-oriented electrical steel sheet is necessary to contain Al and N as an ingredient forming an inhibitor of Al: 0.010-0.050 mass % and N: 0.003-0.020 mass %, respectively, to cause secondary recrystallization to increase integration degree into Goss orientation. When Al is less than 0.050 mass % or when N is less than 0.003 mass %, formation of AlN is insufficient and the integration degree of Goss orientation is lowered. On the other hand, when Al exceeds 0.050 mass % or when N exceeds 0.02 mass %, the amount of AlN formed becomes excessive and the secondary recrystallization of Goss orientation is blocked. Therefore, the Al and N contents are necessary to be the above ranges. The ranges are preferably Al: 0.015-0.035 mass % and N: 0.005-0.015 mass %. Moreover, when AlN is used as an inhibitor, N may be contained in an amount required for the secondary recrystallization in the melting of steel, or may be contained in an amount required for the secondary recrystallization by subjecting to nitriding at any step from the cold rolling to the finish annealing for the secondary recrystallization.

As an inhibitor other than AlN can be mentioned MnSe and MnS. In using such an inhibitor, S and Se are preferable to be contained within ranges of Se: 0.003-0.030 mass % and S: 0.002-0.03 mass %, respectively. More preferably, they are within ranges of Se: 0.005-0.025 mass % and S: 0.002-0.01 mass %. Moreover, the inhibitors of MnSe and MnS are preferable to be used together with AlN. Also, MnSe and MnS may be used alone or may be used together.

Moreover, the slab may contain one or more selected from Cr, Cu and P within ranges of Cr: 0.01-0.50 mass %, Cu: 0.01-0.50 mass % and P: 0.005-0.50 mass % for the purpose of further decreasing the iron loss. Further, it may contain one or more selected from Ni, Sb, Sn, Bi, Mo, B, Te, Nb, V and Ta within ranges of Ni: 0.010-1.50 mass %, Sb: 0.005-0.50 mass %, Sn: 0.005-0.50 mass %, Bi: 0.005-0.50 mass %, Mo: 0.005-0.10 mass %, B: 0.0002-0.0025 mass %, Te: 0.0005-0.010 mass %, Nb: 0.0010-0.010 mass %, V: 0.001-0.010 mass % and Ta: 0.001-0.010 mass % for the purpose of increasing the magnetic flux density.

The slab is preferable to be produced by melting a steel having the above chemical composition through a usual refining process and further performing a usual ingot making-blooming method or continuous casting method. Thereafter, the slab is hot rolled by reheating to a temperature of about 1400° C. according to the usual manner. However, when AlN is used as an inhibitor and nitriding is performed on the way of the production process, the reheating temperature may be made lower than the above value.

Then, the hot rolled sheet obtained by hot rolling is subjected to a hot band annealing, if necessary. The temperature of this hot band annealing is preferable to be 800-1150° C. for providing good magnetic properties. When it is lower than 800° C., a band structure formed by hot rolling is retained and it becomes difficult to provide primary recrystallization structure of neat grains and hence growth of secondary recrystallized grains is blocked. On the other hand, when it exceeds 1150° C., the grain size after the hot band annealing is too coarsened and it is difficult to provide primary recrystallization structure of neat grains.

The steel sheet after the hot rolling or after the hot band annealing followed to the hot rolling is subjected to one cold rolling or two or more cold rollings interposing an intermediate annealing therebetween to form a cold rolled sheet with a final sheet thickness. An annealing temperature of the intermediate annealing is preferably 900-1200° C. When it is lower than 900° C., the recrystallized grains after the intermediate annealing become finer and further Goss nuclei in the primary recrystallization structure are decreased to deteriorate the magnetic properties of a product sheet. On the other hand, when it exceeds 1200° C., the crystal grains become too coarse and it is difficult to provide primary recrystallization structure of neat grains like the hot band annealing.

In the cold rolling to the final sheet thickness (final cold rolling), a rolling reduction is necessary to be 85-94% for controlling grain size and crystal orientation of secondary recrystallized grains to proper ranges as previously mentioned. Preferably, it is 87-92%.

The cold rolled sheet with the final sheet thickness is then subjected to a primary recrystallization annealing combined with decarburization annealing.

An annealing temperature of the primary recrystallization annealing is preferably 800-900° C. from a viewpoint of rapidly promoting decarburization reaction in combining with decarburization annealing. Even in C: not more than 0.005 mass % not requiring decarburization, therefore, it is necessary to perform an annealing in the above atmosphere for ensuring a subscale layer required for the formation of forsterite. In this regard, C in the steel sheet after the decarburization annealing is necessary to be not more than 0.0050 mass % from a viewpoint of the prevention of magnetic aging. Preferably, it is not more than 0.0030 mass %. Moreover, the primary recrystallization annealing and the decarburization annealing may be performed separately.

It is further important that a temperature holding treatment of holding any temperature T of 250-600° C. for 1-10 seconds is performed in the heating process of the primary recrystallization annealing and thereafter the heating is performed at a heating rate of not less than 80° C./s from the holding temperature T to 700° C. as previously mentioned. Moreover, the holding temperature in the temperature holding treatment is not indispensable to be constant, and a temperature change of not more than ±10° C./s may be supposed to be constant because the effect similar to the temperature holding is obtained.

In the primary recrystallization annealing, it is further necessary to form an internal oxide layer effective for the control of nitriding during the finish annealing. Concretely, it is necessary that a ratio (Iₘₐₓ/Iₘᵢₙ) of a maximum value Iₘₐₓ to a minimum value Iₘᵢₙ presented in a position deeper than the maximum value Iₘₐₓ in an emission intensity profile of Si in a depth direction when the steel sheet surface after the primary recrystallization annealing is analyzed by a glow-discharge optical emission spectrometry (GDS) is not less than 1.5 for formation of the internal oxide layer. To this end, it is necessary that the heating is performed from 700° C. to a soaking temperature in an atmosphere having an oxygen potential P_{H2O}/P_{H2} of 0.2-0.4 at a heating rate of not more than 15° C./s and further an oxygen potential P_{H2O}/P_{H2} in the soaking is 0.3-0.5.

The steel sheet subjected to the primary recrystallization annealing is subjected to a finish annealing after an annealing separator composed mainly of MgO is applied and dried onto the steel sheet surface to form a forsterite film on the steel sheet surface. In the finish annealing, it is preferable that secondary recrystallization is generated and completed by keeping at a temperature of about 800-1050° C. for not less than 20 hours and then a temperature is raised to about 1200° C. for subjecting to a purification treatment. By performing the purification treatment are decreased Al, N, S and Se as an inhibitor forming ingredient added to the raw slab to an inevitable impurity level in an iron matrix after the removal of coatings from a surface of a product sheet, whereby the magnetic properties are more improved.

Thereafter, the steel sheet after the finish annealing is subjected to a shape correction by flattening annealing after the unreacted annealing separator adhered to the steel sheet surface is removed by water washing, brushing, pickling or the like, which is effective for decreasing the iron loss. It is because the finish annealing is usually performed in a coil form so that the properties are deteriorated due to winding curl of the coil in the measurement of the iron loss.

Furthermore, the steel sheet is necessary to form an insulation coating on the steel sheet surface in the flattening annealing or before or after thereof. The insulation coating is necessary to be a tension coating applying tension to the steel sheet for decreasing the iron loss. For example, it is preferable to apply an insulation coating made of the aforementioned phosphate-chromate-colloidal silica.

The steel sheet is necessary to be subjected to a magnetic domain refining treatment for further decreasing the iron loss. When grooves are formed on the steel sheet surface as a method of the magnetic domain refining treatment, it is preferable that a width of the groove is 20-250 μm and a depth of the groove is 2-15% of the sheet thickness. When the width is too narrow or the depth is too shallow, the magnetic domain refining effect cannot be obtained sufficiently. Moreover, the method of forming the groove is not particularly limited, and the formation may be performed, for example, by etching on one side face or both faces of the steel sheet, knurling with geared rolls, laser irradiation or the like at any step after the final cold rolling to a final sheet thickness.

When strain regions are introduced into the steel sheet surface as a method of the magnetic domain refining treatment, the introduction method of the strain region is not particularly limited, and methods such as laser irradiation, electron beam irradiation, plasma jet spraying, ion beam spraying and so on may be used. The strain regions introduced by these methods are preferable to be formed after the finish annealing because recovery is caused by annealing at a higher temperature to lose the magnetic domain refining effect.

Moreover, whether or not the magnetic domains are refined by the formation of the grooves or the introduction of the strain regions can be confirmed by the formation of closure domain extending along a line direction in linear portion of the strain-introduced steel sheet surface. The closure domain can be easily observed without the removal of the coatings from the steel sheet surface by a Bitter method wherein a magnetic colloid solution is dropped onto the steel sheet surface or with a commercially available magnet viewer utilizing the same. As a matter of course, there can be used an observation method with a Kerr-effect microscope using a magneto-optical effect, a transmission electron microscope using electrons as a probe, a spin-polarized scanning type electron microscope or the like. If the closure domain is not formed, the magnetic domain refining effect cannot be obtained and hence the sufficient effect of decreasing the iron loss cannot be obtained.

### Example 1

A steel slab having a chemical composition comprising C: 0.070 mass %, Si: 3.50 mass %, Mn: 0.12 mass %, Al: 0.025 mass %, N: 0.012 mass % and the remainder being Fe and inevitable impurities is produced by a continuous casting method, reheated by induction heating to a temperature of 1415° C., and hot rolled to form a hot rolled sheet of 2.5 mm in thickness. Then, the hot rolled sheet is subjected to a hot band annealing at 1000° C. for 50 seconds, cold rolled to an intermediate thickness of 1.9 mm, subjected to an intermediate annealing at 1100° C. for 25 seconds, and finally cold rolled to form a cold rolled sheet having a sheet thickness of 0.23 mm (final cold rolling reduction: 87.9%).

Next, continuous linear grooves having a width of 70 μm and a depth of 28 μm are formed on one side of the cold rolled sheet at an angle of 75° crossing to the rolling direction and an interval d in the rolling direction of 3 mm by electrolytic etching.

Next, the cold rolled sheet is subjected to a primary recrystallization annealing combined with decarburization annealing by soaking at 850° C. for 120 seconds. In this instance, conditions of a temperature holding treatment performed at a temperature T in the heating process and a heating rate from the holding temperature T to 700° C. are variously changed as shown in Table 1. Further, heating from 700° C. to a soaking temperature of 850° C. is performed at a heating rate of 10° C./s in an atmosphere having an oxygen potential P_{H2O}/P_{H2} of 0.30, and an oxygen potential P_{H2O}/P_{H2} of an atmosphere in the soaking process (in decarburization annealing) is 0.39.

Then, a sample is cut out from a widthwise center portion of the steel sheet after the primary recrystallization annealing and an emission intensity of Si in a direction from a one-side outermost surface of the sample toward a center of the sheet thickness is measured with a high-frequency glow-discharge emission spectrometry device GDS (System 3860 made by Rigaku Corporation). From the thus obtained emission intensity profile of Si in the thickness direction is determined Iₘₐₓ/Iₘᵢₙ by the aforementioned method. As a result, a value of Iₘₐₓ/Iₘᵢₙ is within a range of 1.6-1.7 in all of the steel sheets after the primary recrystallization annealing. Moreover, the analysis with GDS and measurement of Iₘₐₓ/Iₘᵢₙ even in subsequent examples are the same as mentioned above.

Then, the steel sheet after the primary recrystallization annealing is subjected to a finish annealing by purification treatment at 1200° C. for 10 hours after the steel sheet surface is coated with an annealing separator composed mainly of MgO and dried and subjected to secondary recrystallization. Moreover, an atmosphere in the finish annealing is H₂ in the keeping of 1200° C. for the purification treatment and N₂ in the temperature rising and dropping.

Finally, a tension insulation coating composed mainly of magnesium phosphate containing colloidal silica is applied onto both surfaces of the steel sheet after the finish annealing at a coating weight of 5 g/m² per one surface and baked to obtain a product coil.

From a longitudinal center portion of the thus obtained product coil are cut out 10 test specimens of 100 mm width×300 mm length in the rolling direction as a lengthwise direction per widthwise direction to measure an iron loss W_{17/50} by a method described in JIS C2556.

Also, crystal orientations of the secondary recrystallized grains in the test specimens after the measurement of iron loss are measured over a whole surface at a pitch of 2 mm in the widthwise direction and the rolling direction by an X-ray diffraction device to determine an average value [β] of a deviation angle β, an area ratio S_{α6.5} of crystal grains having a deviation angle α of not more than 6.5° and an area ratio S_{β2.5} of crystal grains having a deviation angle β of not more than 2.5°.

Further, the insulation coating and forsterite film are removed from the surface of the test specimen after the measurement of iron loss to expose crystal grain boundaries and straight line extending in the rolling direction is drawn at a pitch of 5 mm to measure the number of grain boundaries crossing the straight line, from which is determined an average length [L] of secondary recrystallized grains in the rolling direction.

The measured results are also shown in Table 1. As seen from this table, the iron loss property is excellent in all of the grain-oriented electrical steel sheets controlled by properly adjusting the conditions of the temperature holding treatment on the way of the heating in the primary recrystallization annealing (temperature T, time) and the heating rate from the holding temperature T to 700° C. and satisfying the average length in rolling direction [L] and crystal orientation ([β], S_{α6.5}, S_{β2.5}) of secondary recrystallized grains.

TABLE 1

| | Production condition | | | Properties of product | | | | | | |
|---|---|---|---|---|---|---|---|---|---|---|
| | Holding | Holding | Heating rate from | [L] | [β] | Left side of | S_{α6.5} | S_{β2.5} | Iron loss | |
| No | temperature T(° C.) | time (s) | T to 700° C. (° C./s) | (mm) | (°) | equation (1) | (%) | (%) | W_{17/50} (W/kg) | Remarks |
| 1 | — | 0 | 50 | 23 | 2.01 | 54.42 | 89.4 | 69.5 | 0.726 | Comparative Example |
| 2 | 500 | 2 | 50 | 21 | 1.94 | 51.32 | 90.6 | 72.3 | 0.717 | Comparative Example |
| 3 | — | 0 | 100 | 15 | 1.88 | 44.38 | 88.4 | 76.5 | 0.718 | Comparative Example |
| 4 | 200 | 2 | 100 | 18 | 1.87 | 47.23 | 88.9 | 76.8 | 0.712 | Comparative Example |
| 5 | 300 | 2 | 100 | 10 | 1.86 | 39.07 | 90.7 | 77.1 | 0.691 | Example |
| 6 | 500 | 2 | 100 | 13 | 1.85 | 41.92 | 91.3 | 78.7 | 0.694 | Example |
| 7 | 650 | 2 | 100 | 18 | 1.86 | 47.07 | 94.1 | 76.9 | 0.743 | Comparative Example |
| 8 | 300 | 7 | 100 | 12 | 1.88 | 41.38 | 91.2 | 76.2 | 0.694 | Example |
| 9 | 500 | 7 | 100 | 14 | 1.86 | 43.07 | 91.4 | 77.5 | 0.695 | Example |
| 10 | 300 | 12 | 100 | 18 | 1.91 | 47.85 | 90.5 | 73.4 | 0.724 | Comparative Example |
| 11 | 500 | 12 | 100 | 17 | 1.89 | 46.54 | 91.6 | 75.6 | 0.721 | Comparative Example |
| 12 | — | 0 | 150 | 15 | 1.86 | 44.07 | 88.1 | 75.8 | 0.731 | Comparative Example |
| 13 | 300 | 2 | 150 | 9 | 1.83 | 37.60 | 91.2 | 76.1 | 0.682 | Example |
| 14 | 500 | 2 | 150 | 11 | 1.82 | 39.45 | 91.5 | 79.3 | 0.684 | Example |
| 15 | 300 | 7 | 150 | 10 | 1.85 | 38.92 | 91.8 | 77.6 | 0.686 | Example |
| 16 | 500 | 7 | 150 | 11 | 1.85 | 39.92 | 92.1 | 77.2 | 0.691 | Example |
| 17 | 300 | 12 | 150 | 15 | 1.86 | 44.07 | 92.5 | 76.9 | 0.722 | Comparative Example |
| 18 | 500 | 12 | 150 | 17 | 1.87 | 46.23 | 92.7 | 77.1 | 0.718 | Comparative Example |
| 19 | — | 0 | 300 | 11 | 1.93 | 41.17 | 87.8 | 73.3 | 0.712 | Comparative Example |
| 20 | 300 | 2 | 300 | 7 | 1.87 | 36.23 | 90.2 | 76.2 | 0.677 | Example |
| 21 | 500 | 2 | 300 | 8 | 1.88 | 37.38 | 90.3 | 75.8 | 0.681 | Example |
| 22 | 300 | 7 | 300 | 8 | 1.88 | 37.38 | 90.6 | 75.7 | 0.683 | Example |
| 23 | 500 | 7 | 300 | 9 | 1.88 | 38.38 | 90.8 | 75.9 | 0.687 | Example |
| 24 | 300 | 12 | 300 | 13 | 1.89 | 42.54 | 91.2 | 74.6 | 0.717 | Comparative Example |
| 25 | 500 | 12 | 300 | 14 | 1.88 | 43.38 | 92.1 | 74.4 | 0.719 | Comparative Example |

### Example 2

A steel slab having a chemical composition comprising C: 0.080 mass %, Si: 3.3 mass %, Mn: 0.12 mass %, Al: 0.025 mass %, N: 0.012 mass % and the remainder being Fe and inevitable impurities is produced by a continuous casting method, reheated by induction heating to a temperature of 1400° C., and hot rolled to form a hot rolled sheet of 2.6 mm in thickness, which is subjected to a hot band annealing at 1000° C. for 50 seconds, cold rolled to an intermediate thickness of 1.8 mm, subjected to an intermediate annealing at 1100° C. for 30 seconds, and finally cold rolled at a rolling reduction of 89.4% to form a cold rolled sheet having a sheet thickness of 0.23 mm.

Then, the cold rolled sheet is subjected to a primary recrystallization annealing combined with decarburization annealing at 840° C. for 120 seconds. In this instance, a temperature holding treatment is performed at a temperature of 400° C. for 1.5 seconds on the way of the heating process, and thereafter the heating is performed from 400° C. to 700° C. at a heating rate of 150° C./s and then a heating rate from 700° C. to a soaking temperature of 840° C., an oxygen potential P_{H2O}/P_{H2} of an atmosphere during this zone and an oxygen potential P_{H2O}/P_{H2} of an atmosphere in the soaking process are changed into various conditions shown in Table 2. Also, a sample is cut out from a widthwise center portion of the steel sheet after the primary recrystallization annealing to measure Iₘₐₓ/Iₘᵢₙ in the same manner as in Example 1.

Next, the steel sheet after the primary recrystallization annealing is coated on its surface with an annealing separator composed mainly of MgO, dried, subjected to a secondary recrystallization and further to a finish annealing by purification treatment at 1200° C. for 10 hours. Moreover, an atmosphere in the finish annealing is H₂ in the keeping of 1200° C. for the purification treatment and N₂ in the temperature rising and dropping.

Then, a tension insulation coating composed mainly of magnesium phosphate containing colloidal silica is applied and baked onto both surfaces of the steel sheet after the finish annealing at a coating weight of 5 g/m² per one side surface.

Finally, a magnetic domain refining treatment is performed by continuously irradiating CO₂ laser onto the one side surface of the steel sheet at an angle of 80° crossing to the rolling direction and an interval d in the rolling direction of 6 mm under conditions of an output of 100 W, a beam focusing diameter of 210 μm and a scanning rate of 10 m/s to form linear strain regions, whereby a product coil is obtained. Moreover, a magnetic domain structure of the steel sheet surface is observed with a Bitter method after the magnetic domain refining treatment, from which the formation of closure domains is confirmed in the laser irradiated portion.

From a longitudinal center portion of the thus obtained product coil are cut out 10 test specimens of 100 mm width×300 mm length in the rolling direction as a lengthwise direction per widthwise direction to measure an iron loss W_{17/50} by a method described in JIS C2556.

The measured results are also shown in Table 2. As seen from this table, the iron loss property is excellent in all of the grain-oriented electrical steel sheets wherein Iₘₐₓ/Iₘᵢₙ average length in rolling direction [L] and crystal orientation ([β], S_{α6.5}, S_{β2.5}) of secondary recrystallized grains satisfy our conditions.

TABLE 2

| | Production conditions | | | | Properties of product | | | | | | |
|---|---|---|---|---|---|---|---|---|---|---|---|
| | Heating rate from | P_{H2O}/P_{H2} from | P_{H2O}/P_{H2} of | | | | Left side | | | Iron loss | |
| | 700 to 850° C. | 700° C. to | soaking | | [L] | [β] | of | S_{α6.5} | S_{β2.5} | W_{17/50} | |
| No | (° C./s) | 850° C. | zone | Iₘₐₓ/Iₘᵢₙ | (mm) | (°) | equation (1) | (%) | (%) | (W/kg) | Remarks |
| 1 | 5 | 0.15 | 0.25 | 1.47 | 21 | 1.87 | 50.23 | 91.2 | 76.2 | 0.722 | Comparative Example |
| 2 | 5 | 0.15 | 0.45 | 1.34 | 20 | 1.95 | 50.48 | 88.8 | 73.5 | 0.718 | Comparative Example |
| 3 | 5 | 0.25 | 0.25 | 1.45 | 17 | 1.88 | 46.38 | 90.7 | 75.7 | 0.709 | Comparative Example |
| 4 | 5 | 0.25 | 0.35 | 1.64 | 12 | 1.76 | 39.51 | 91.4 | 77.6 | 0.678 | Example |
| 5 | 5 | 0.25 | 0.45 | 1.57 | 14 | 1.78 | 41.82 | 91.0 | 77.3 | 0.681 | Example |
| 6 | 5 | 0.25 | 0.55 | 1.48 | 19 | 1.81 | 47.29 | 88.6 | 76.4 | 0.712 | Comparative Example |
| 7 | 5 | 0.35 | 0.25 | 1.44 | 18 | 1.86 | 47.07 | 89.5 | 75.8 | 0.708 | Comparative Example |
| 8 | 5 | 0.35 | 0.35 | 1.59 | 13 | 1.83 | 41.60 | 91.1 | 76.3 | 0.683 | Example |
| 9 | 5 | 0.35 | 0.45 | 1.56 | 14 | 1.85 | 42.92 | 90.2 | 76.1 | 0.686 | Example |
| 10 | 5 | 0.35 | 0.55 | 1.43 | 19 | 1.89 | 48.54 | 89.5 | 75.6 | 0.704 | Comparative Example |
| 11 | 5 | 0.45 | 0.25 | 1.47 | 23 | 1.87 | 52.23 | 87.2 | 76.1 | 0.723 | Comparative Example |
| 12 | 5 | 0.45 | 0.45 | 1.38 | 22 | 1.88 | 51.38 | 88.5 | 75.9 | 0.717 | Comparative Example |
| 13 | 10 | 0.15 | 0.25 | 1.46 | 18 | 1.86 | 47.07 | 90.1 | 76.3 | 0.711 | Comparative Example |
| 14 | 10 | 0.25 | 0.25 | 1.48 | 17 | 1.88 | 46.38 | 91.2 | 75.4 | 0.715 | Comparative Example |
| 15 | 10 | 0.25 | 0.35 | 1.56 | 13 | 1.83 | 41.60 | 90.8 | 76.3 | 0.695 | Example |
| 16 | 10 | 0.25 | 0.45 | 1.58 | 14 | 1.81 | 42.29 | 90.6 | 77.1 | 0.692 | Example |
| 17 | 10 | 0.45 | 0.45 | 1.56 | 16 | 1.92 | 46.01 | 90.2 | 73.5 | 0.703 | Comparative Example |
| 18 | 20 | 0.15 | 0.25 | 1.45 | 17 | 1.85 | 45.92 | 91.6 | 75.6 | 0.702 | Comparative Example |
| 19 | 20 | 0.25 | 0.35 | 1.43 | 19 | 1.83 | 47.60 | 90.8 | 75.8 | 0.706 | Comparative Example |
| 20 | 20 | 0.35 | 0.35 | 1.40 | 21 | 1.84 | 49.76 | 89.4 | 76.1 | 0.713 | Comparative Example |
| 21 | 20 | 0.45 | 0.45 | 1.37 | 22 | 1.86 | 51.07 | 88.0 | 75.4 | 0.715 | Comparative Example |

### Example 3

A steel slab having a chemical composition comprising C: 0.080 mass %, Si: 3.40 mass %, Mn: 0.10 mass %, Al: 0.024 mass %, N: 0.080 mass % and the remainder being Fe and inevitable impurities is produced by a continuous casting method, reheated by induction heating to a temperature of 1420° C., and hot rolled to form a hot rolled sheet of 2.4 mm in thickness, which is subjected to a hot band annealing at 1100° C. for 40 seconds, cold rolled to a thickness of 1.7 mm, subjected to an intermediate annealing at 1100° C. for 25 seconds, and finally cold rolled at a rolling reduction of 86.4% to form a cold rolled sheet having a sheet thickness of 0.23 mm.

Then, the cold rolled sheet is subjected to a primary recrystallization annealing combined with decarburization annealing at 845° C. for 100 seconds. In this instance, a temperature holding treatment is performed at a temperature of 500° C. for 3 seconds on the way of the heating process, and thereafter the heating is performed from 500° C. to 700° C. at a heating rate of 200° C./s and then a zone from 700° C. to a soaking temperature of 845° C. is heated at a heating rate of not more than 8° C./s in an atmosphere having an oxygen potential P_{H2O}/P_{H2} of 0.24 and a soaking treatment is performed in an atmosphere having an oxygen potential P_{H2O}/P_{H2} of 0.33. A sample is cut out from a widthwise center portion of the steel sheet after the primary recrystallization annealing to measure Iₘₐₓ/Iₘᵢₙ in the same manner as in Example 1, and as a result, the measured value is 1.68.

Next, the steel sheet after the primary recrystallization annealing is coated on its surface with an annealing separator composed mainly of MgO, dried, subjected to a secondary recrystallization and further to a finish annealing by purification treatment at 1200° C. for 10 hours. Moreover, an atmosphere in the finish annealing is H₂ in the keeping of 1200° C. for the purification treatment and N₂ in the temperature rising and dropping.

Finally, a tension insulation coating composed mainly of magnesium phosphate containing colloidal silica is applied and baked onto both surfaces of the steel sheet after the finish annealing at a coating weight of 5 g/m2 per one side surface.

In the manufacture of the product coil, three magnetic domain refining treatments of groove formation, laser irradiation and electron beam irradiation shown in Table 3 are performed on the way of the manufacturing process. Concretely, continuously linear grooves having a width of 75 μm and a depth of 25 μm are formed on the one side surface of the steel sheet after the final cold rolling by electrolytic etching at an angle of 80° crossing to the rolling direction by changing an interval d in the rolling direction as shown in Table 3. In laser irradiation, CO₂ laser is continuously irradiated onto the one side surface of the product coil at an angle of 80° crossing to the rolling direction under conditions of an output of 120 W, a beam focusing diameter of 220 μm and a scanning rate of 12 m/s by changing an interval d in the rolling direction as shown in Table 3, whereby linear strain is introduced into the steel sheet surface. In electron beam irradiation, electron beams are irradiated linearly and continuously onto the one side surface of the product coil with an electron beam acceleration device at an acceleration voltage of 70 kV under a vacuum of 0.1 Pa, a beam current of 15 mA and an angle of 80° crossing to the rolling direction by changing an interval d in the rolling direction as shown in Table 3, whereby linear strain is introduced into the steel sheet surface. In the laser irradiation and electron beam irradiation, we confirmed that closure domains are formed in the laser irradiated portion when the magnetic domain structure of the steel sheet surface is observed by a Bitter method after the magnetic domain refining treatment.

From a longitudinal center portion of the thus obtained product coil are cut out 10 test specimens of 100 mm width×300 mm length in the rolling direction as a lengthwise direction per widthwise direction to measure an iron loss W_{17/50} by a method described in JIS C2556.

Also, crystal orientations of secondary recrystallized grains in the test specimens after the measurement of iron loss are measured over a whole surface at a pitch of 2 mm in the widthwise direction and the rolling direction by an X-ray diffraction device to determine an average value [β] of a deviation angle β, an area ratio S_{α6.5} of crystal grains having a deviation angle α of not more than 6.5° and an area ratio Sβ2.5 of crystal grains having a deviation angle β of not more than 2.5°.

Further, the insulation coating and forsterite film are removed from the surface of the test specimen after the measurement of iron loss to expose crystal grain boundaries, and straight line extending in the rolling direction is drawn at a pitch of 5 mm to measure the number of grain boundaries crossing the straight line, from which is determined an average length [L] of secondary recrystallized grains in the rolling direction.

The measured results are also shown in Table 3. As seen from this table, the iron loss property is excellent in all of the grain-oriented electrical steel sheets wherein the interval d of the magnetic domain refining treatment in the rolling direction satisfies our condition.

TABLE 3

| | Production conditions | | | |
|---|---|---|---|---|
| | Magnetic | Interval d of | Iron | |
| | domain | magnetic | loss | |
| | refining | domain | W_{17/50} | |
| No | method | refining (mm) | (W/kg) | Remarks |
| 1 | None | — | 0.810 | Comparative |
| | | | | Example |
| 2 | Groove | 0.5 | 0.706 | Comparative |
| | formation | | | Example |
| 3 | | 3.0 | 0.677 | Example |
| 4 | | 6.0 | 0.681 | Example |
| 5 | | 9.0 | 0.693 | Example |
| 6 | | 12.0 | 0.709 | Comparative |
| | | | | Example |
| 7 | Laser | 0.5 | 0.705 | Comparative |
| | irradiation | | | Example |
| 8 | | 3.0 | 0.681 | Example |
| 9 | | 6.0 | 0.676 | Example |
| 10 | | 9.0 | 0.683 | Example |
| 11 | | 12.0 | 0.705 | Comparative |
| | | | | Example |
| 12 | Electric beam | 0.5 | 0.705 | Comparative |
| | irradiation | | | Example |
| 13 | | 3.0 | 0.681 | Example |
| 14 | | 6.0 | 0.673 | Example |
| 15 | | 9.0 | 0.682 | Example |
| 16 | | 12.0 | 0.706 | Comparative |
| | | | | Example |

### Example 4

An Si-containing steel slab having a chemical composition shown in Table 4 is produced by a continuous casting method, heated by an induction heating to a temperature of 1420° C. and hot rolled to form a hot rolled sheet of 2.4 mm in thickness, which is subjected to a hot band annealing at 1100° C. for 40 seconds, cold rolled to a thickness of 1.7 mm, subjected to an intermediate annealing at 1100° C. for 25 seconds, and finally cold rolled at a rolling reduction of 86.4% to form a cold rolled sheet having a sheet thickness of 0.23 mm.

After continuous grooves with a width of 75 μm and a depth of 25 μm are formed on the one side surface of the cold rolled sheet at an angle of 75° from the rolling direction and an interval d in the rolling direction of 3 mm by electrolytic etching, the sheet is subjected to a primary recrystallization annealing combined with decarburization annealing at 850° C. for 170 seconds. In this instance, a temperature holding treatment is performed at a temperature of 300° C. for 2 seconds on the way of the heating process, and thereafter the heating is performed to 700° C. at a heating rate of 100° C./s and then a zone from 700° C. to a soaking temperature of 850° C. is heated at a heating rate of 5° C./s in an atmosphere having an oxygen potential P_{H2O}/P_{H2} of 0.25 and a soaking treatment is performed in an atmosphere having an oxygen potential P_{H2O}/P_{H2} of 0.35. Moreover, a sample is cut out from a widthwise center portion of the steel sheet after the primary recrystallization annealing to measure Iₘₐₓ/Iₘᵢₙ in the same manner as in Example 1, and as a result, the measured value is 1.65.

Next, the steel sheet is coated on its surface with an annealing separator composed mainly of MgO, dried, subjected to a secondary recrystallization and further to a finish annealing by purification treatment at 1200° C. for 10 hours. An atmosphere in the finish annealing is H₂ in the keeping of 1200° C. for the purification treatment and N₂ in the temperature rising including secondary recrystallization and in the temperature dropping. Then, an insulation tension coating composed mainly of magnesium phosphate containing colloidal silica is applied and baked onto both surfaces of the steel sheet after the finish annealing at a coating weight of 5 g/m² per one side surface.

From a longitudinal center portion of the thus obtained product coil are cut out 10 test specimens of 100 mm width×300 mm length in the rolling direction as a lengthwise direction per widthwise direction to measure an iron loss W_{17/50} by a method described in JIS C2556.

Also, crystal orientations of secondary recrystallized grains in the test specimens after the measurement of iron loss are measured over a whole surface at a pitch of 2 mm in the widthwise direction and the rolling direction by an X-ray diffraction device to determine an average value [β] of a deviation angle β, an area ratio S_{α6.5} of crystal grains having a deviation angle α of not more than 6.5° and an area ratio S_{β2.5} of crystal grains having a deviation angle β of not more than 2.5°.

Further, the insulation coating and forsterite film are removed from the surface of the test specimen after the measurement of iron loss to expose crystal grain boundaries, and straight line extending in the rolling direction is drawn at a pitch of 5 mm to measure the number of grain boundaries crossing the straight line, from which is determined an average length [L] of secondary recrystallized grains in the rolling direction.

The measured results are also shown in Table 4. As seen from this table, the iron loss property is excellent in all of the grain-oriented electrical steel sheets wherein the chemical composition of the steel slab, Iₘₐₓ/Iₘₘ, average length in rolling direction [L] and crystal orientation ([β], S_{α6.5}, S_{β2.5}) of secondary recrystallized grains satisfy our conditions.

TABLE 4

| | | | | | | | | | | Properties of product | | | | | | |
|---|---|---|---|---|---|---|---|---|---|---|---|---|---|---|---|---|
| | | | | | | | | | | | | Left side | | | Iron Loss | |
| | Production conditions | | | | | | | | | [L] | [β] | of equation | S_{α6.5} | S_{β2.5} | W_{17/50} | |
| No | C | Si | Mn | Al | N | S | Se | Others | Iₘₐₓ/Iₘᵢₙ | (mm) | (°) | (1) | (%) | (%) | (W/kg) | Remarks |
| 1 | 0.15 | 3.2 | 0.07 | 0.032 | 0.0021 | — | — | — | 1.68 | 18 | 2.29 | 53.79 | 89.2 | 71.2 | 0.812 | Comparative |
| | | | | | | | | | | | | | | | | Example |
| 2 | 0.07 | 3.3 | 1.20 | 0.014 | 0.006 | — | — | — | 1.71 | 12 | 2.03 | 43.73 | 88.3 | 77.4 | 0.765 | Comparative |
| | | | | | | | | | | | | | | | | Example |
| 3 | 0.05 | 3.3 | 0.21 | 0.063 | 0.011 | — | — | — | 1.75 | 5 | 3.12 | 53.77 | 62.6 | 58.2 | 0.746 | Comparative |
| | | | | | | | | | | | | | | | | Example |
| 4 | 0.06 | 3.4 | 0.15 | 0.0072 | 0.017 | — | — | — | 1.70 | 8 | 2.60 | 48.64 | 68.2 | 54.6 | 0.732 | Comparative |
| | | | | | | | | | | | | | | | | Example |
| 5 | 0.08 | 3.5 | 0.22 | 0.031 | 0.032 | — | — | — | 1.66 | 25 | 3.60 | 81.27 | 78.5 | 61.2 | 0.901 | Comparative |
| | | | | | | | | | | | | | | | | Example |
| 6 | 0.06 | 3.3 | 0.08 | 0.022 | 0.0091 | — | — | — | 1.65 | 9 | 2.01 | 40.42 | 91.7 | 77.6 | 0.691 | Example |
| 7 | 0.07 | 3.2 | 0.12 | 0.019 | 0.014 | — | — | — | 1.73 | 12 | 1.86 | 41.07 | 93.5 | 76.5 | 0.684 | Example |
| 8 | 0.06 | 3.2 | 0.10 | 0.026 | 0.0085 | 0.005 | — | — | 1.72 | 13 | 1.82 | 41.45 | 92.4 | 76.2 | 0.692 | Example |
| 9 | 0.06 | 3.2 | 0.10 | 0.026 | 0.0085 | — | 0.02 | — | 1.68 | 15 | 1.83 | 43.60 | 92.8 | 75.8 | 0.688 | Example |
| 10 | 0.06 | 3.2 | 0.10 | 0.026 | 0.0085 | 0.005 | 0.01 | — | 1.69 | 14 | 1.81 | 42.29 | 93.6 | 76.0 | 0.693 | Example |
| 11 | 0.06 | 3.2 | 0.08 | 0.026 | 0.0085 | — | — | Cr: 0.02, | 1.71 | 10 | 1.79 | 37.98 | 94.1 | 76.5 | 0.681 | Example |
| | | | | | | | | Ni: 0.02, | | | | | | | | |
| | | | | | | | | Bi: 0.008, | | | | | | | | |
| | | | | | | | | B: 0.001 | | | | | | | | |
| 12 | 0.06 | 3.2 | 0.08 | 0.026 | 0.0085 | — | — | Cu: 0.05, | 1.68 | 11 | 1.76 | 38.51 | 94.2 | 77.6 | 0.683 | Example |
| | | | | | | | | Sb: 0.03, | | | | | | | | |
| | | | | | | | | Mo: 0.01, | | | | | | | | |
| | | | | | | | | Te: 0.002 | | | | | | | | |
| 13 | 0.05 | 3.2 | 0.08 | 0.026 | 0.0085 | — | — | P: 0.03, | 1.65 | 9 | 1.77 | 36.67 | 93.9 | 77.1 | 0.679 | Example |
| | | | | | | | | Sn: 0.03, | | | | | | | | |
| | | | | | | | | Nb: 0.003, | | | | | | | | |
| | | | | | | | | V: 0.005, | | | | | | | | |
| | | | | | | | | Ta: 0.003 | | | | | | | | |

1. A method of manufacturing a grain oriented electrical steel sheet comprising:
hot rolling a steel slab having a chemical composition comprising C: 0.002-0.10 mass %, Si: 2.5-5.0 mass %, Mn: 0.01-0.8 mass %, Al: 0.010-0.050 mass % and N: 0.003-0.020 mass % and the remainder being Fe and inevitable impurities to form a hot rolled sheet;
subjecting the hot rolled sheet to one cold rolling or two or more cold rollings and interposing an intermediate annealing therebetween after hot band annealing or without hot band annealing to form a cold rolled sheet having a final thickness;
subjecting the cold rolled sheet to a primary recrystallization annealing;
applying an annealing separator to the surface of the steel sheet; and
subjecting the sheet to a finish annealing and forming a tension coating,
wherein the sheet is subjected to a temperature holding treatment at any temperature T of 250-600° C. for 1-10 seconds in a heating process of the primary recrystallization annealing and then heated from the temperature T to 700° C. at a heating rate of not less than 80° C./s, and a ratio (Iₘₐₓ/Iₘᵢₙ), of a maximum value Iₘₐₓ in an emission intensity profile in a depth direction of Si to a minimum value Iₘᵢₙ found in a position deeper than the maximum value Iₘₐₓ when the steel sheet surface after the primary recrystallization annealing is observed by a glow discharge optical emission spectrometry is not less than 1.5, and continuous or discontinuous linear grooves or linear strain regions are formed on one surface or both surfaces of the steel sheet in a direction crossing the rolling direction at an interval d in the rolling direction of 1-10 mm in any process after the cold rolling such that an area ratio S_{α6.5} of secondary recrystallized grains occupied in the surface of the steel sheet is not less than 90% when an absolute value of an angle α deviated from {110}<001> ideal orientation around a direction perpendicular to a rolling face is less than 6.5° and an area ratio S_{β2.5} of secondary recrystallized grains occupied in the surface of the steel sheet is not less than 75% when an absolute value of an angle β deviated from {110}<001> ideal orientation around a widthwise direction is less than 2.5°, and an average length [L] (mm) of the secondary recrystallized grains in the rolling direction and an average value [β] of the angle β (°) satisfy equations (1) and (2):
15.63×[β]+[L]<44.06 (1)
[L]≤20 (2).

2. The method according to claim 1, wherein the steel slab contains one or two selected from Se: 0.003-0.030 mass % and S: 0.002-0.030 mass % in addition to the above chemical composition.

3. The method according to claim 1, wherein the steel slab contains one or more selected from Cr: 0.01-0.50 mass %, Cu: 0.01-0.50 mass %, P: 0.005-0.50 mass %, Ni: 0.010-1.50 mass %, Sb: 0.005-0.50 mass %, Sn: 0.005-0.50 mass %, Bi: 0.005-0.50 mass %, Mo: 0.005-0.10 mass %, B: 0.0002-0.0025 mass %, Te: 0.0005-0.010 mass %, Nb: 0.0010-0.010 mass %, V: 0.001-0.010 mass % and Ta: 0.001-0.010 mass % in addition to the above chemical composition.

4. The method according to claim 2, wherein the steel slab contains one or more selected from Cr: 0.01-0.50 mass %, Cu: 0.01-0.50 mass %, P: 0.005-0.50 mass %, Ni: 0.010-1.50 mass %, Sb: 0.005-0.50 mass %, Sn: 0.005-0.50 mass %, Bi: 0.005-0.50 mass %, Mo: 0.005-0.10 mass %, B: 0.0002-0.0025 mass %, Te: 0.0005-0.010 mass %, Nb: 0.0010-0.010 mass %, V: 0.001-0.010 mass % and Ta: 0.001-0.010 mass % in addition to the above chemical composition.
